(19) United States
(12) Patent Application Publication
(10) Pub. No.: US 2006/0107067 A1
(43) Pub. Date: May 18, 2006

(54) Identification card with bio-sensor and user authentication method

(76) Inventors: Max Safal, Los Altos, CA (US); Todd Stephen Sachs, Palo Alto, CA (US); John S. Wenstrand, Menlo Park, CA (US)

Correspondence Address: AVAGO TECHNOLOGIES, LTD., P.O. BOX 1920, DENVER, CO, 80201-1920, US

(21) Appl. No.: 10/989,126

(22) Filed: Nov. 15, 2004

(51) Int. Cl. H04K 1/00

(52) U.S. Cl. 713/186

(57) ABSTRACT

An identification card includes a bio-sensor, a memory, and a microprocessor. The bio-sensor is configured to collect a signature biometric characteristic from a verified user. The memory is configured to store the signature biometric characteristic. The microprocessor is coupled to the bio-sensor and the memory. The microprocessor is configured to retrieve the signature biometric characteristic from the memory and to perform a comparison between the signature biometric characteristic and a sample biometric characteristic.

### BACKGROUND

Computer networks and systems have been developed for executing user requested financial transactions for reasons of public convenience and economy. A user can manage money in his or her account without going to the bank and can easily perform product purchases via the internet. Service providers, such as banks or other financial institutions facilitating internet financial transactions, generally employ a network server to confirm whether a person who desires financial service is an authorized user. If security against unauthorized users is not provided, invasion of privacy and fraudulent transactions are perpetrated. Consequently, service providers generally desire a mechanism able to authenticate the identity of the user.

Generally, the identity of a user is authenticated with a password. In particular, a user who wants to make a financial transaction or to otherwise access a financial account selects a password that only he or she knows and registers the selected password with the service provider or the service provider provides a password to the user. Typically, the password is a string of several numbers and/or letters. When the user desires to make a financial transaction, the user provides the password, the network server compares the password transmitted to the previously registered password and authorizes the user. Once authorized, the user is free to make a financial transaction provided the user has available funds.

The password, however, is often generated with several numbers and/or letters based on personal information, such as a telephone number, a birth date, and an ID number, which may be easily found by others. In addition, if the user records the password to enable the user to look up the password, the recorded password may be exposed to others. When the user submits his or her password to the remote network server through a telephone line connection or other network communication connection for authentication, the password is exposed to theft. A stolen password can be easily used in future identity theft.

To provide greater security in the user authentication process, some systems generally employ a one-time use password that is changed each time a user is to be authenticated. In this method, an unauthorized person cannot reuse a password he or she found or stole from the user, because the password is changed each time the user is to be authenticated. The one time password technique employs variable data to generate a variable password, which changes for each authentication operation. For this, a real-time clock and a standardized method of using random numbers is selected and stored on a terminal to be employed by the user. In this respect, only the particular user using employing the user's equipment or terminal that is synchronized with a central network server is able to provide the one-time use password. This method, however, limits the portability and flexibility of the authentication system and other identification thefts continue to be of great concern.

Similar problems as described above are also a concern in the secure access of buildings or other restricted areas by individuals carrying security or identification cards. Such identification cards typically emit a radio frequency (RF) communication to a standard security card reader. The RF information communicated to the reader typically identifies the user and/or at least provides a user password or signal indicating the user has access to the particular area for which the reader is associated. In such a case, the reader will allow a certain secured access, such as a door to be unlocked, a user to access a computer system, etc., based upon authentication of the radio frequency communication received from the security card. However, security cards can easily be lost, stolen, or otherwise obtained by unauthorized individuals. Any unauthorized individuals in possession of the security card can easily access the particular area to which the security card is associated, such as a building, a room, a computer system, etc.

### SUMMARY

One aspect of the present invention relates to an identification card including a bio-sensor, a memory, and a microprocessor. The bio-sensor is configured to collect a signature biometric characteristic from a verified user. The memory is configured to store the signature biometric characteristic. The microprocessor is coupled to the bio-sensor and the memory. The microprocessor is configured to retrieve the signature biometric characteristic from the memory and to perform comparison between the signature biometric characteristic and a sample biometric characteristic.

### BRIEF DESCRIPTION OF THE DRAWINGS

Embodiments of the invention are better understood with reference to the following drawings. Elements of the drawings are not necessarily to scale relative to each other. Like reference numerals designate corresponding similar parts.

FIG. 1 is perspective view illustrating one embodiment of bio-identification card.

FIG. 2 is a block diagram illustrating one embodiment of the bio-identification card of FIG. 1.

FIG. 3 is a block diagram illustrating one embodiment of a bio-identification system which employs a bio-identification card.

FIG. 4 is a flow chart illustrating one embodiment of a method of bio-identification which employs a bio-identification card.

FIG. 5 is a flow chart illustrating one embodiment of an enrollment process within the method of FIG. 4.

FIG. 6 is a flow chart illustrating one embodiment of a user-authentication process within the method of FIG. 4.

FIG. 7 is a block diagram illustrating one embodiment of a bio-identification card.

FIG. 8 is a block diagram illustrating one embodiment of a bio-identification system utilizing a bio-identification card.

FIG. 9 s a flow chart illustrating one embodiment of a method of bio-identification which employs a bio-identification card.

FIG. 10 is a flow chart illustrating one embodiment of a user-authentication process within the method of FIG. 9.

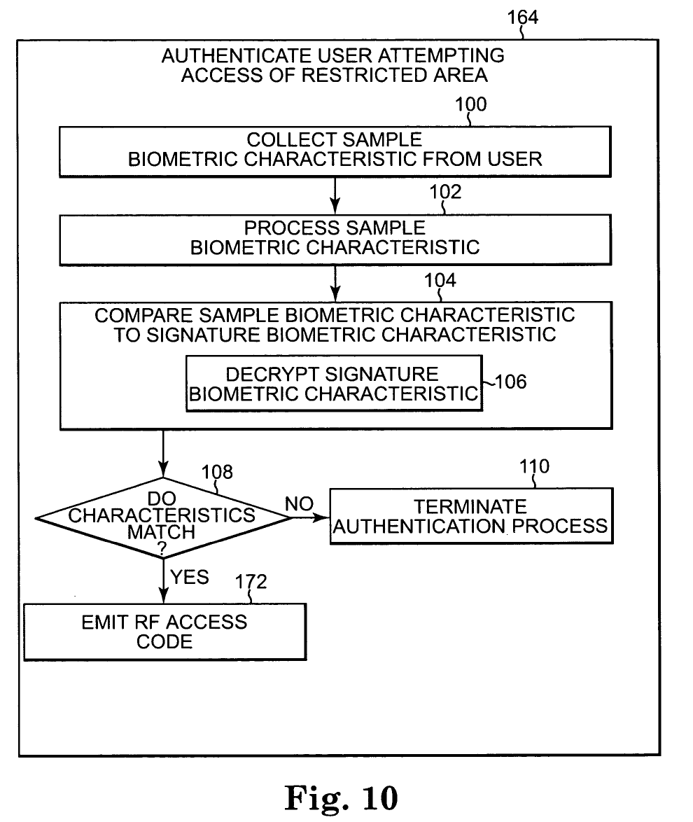

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “upon,” “top,” “bottom,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

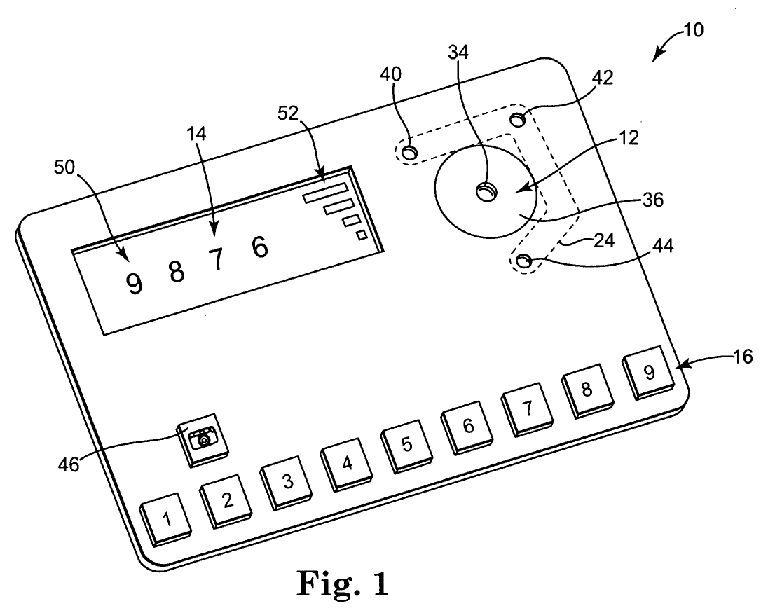

FIG. 1 is a perspective view of one embodiment of a bio-identification card 10. In one embodiment, bio-identification card 10 is sized similar to a credit card to fit within a wallet of a user. In one embodiment, bio-identification card 10 is a credit card. Bio-identification card 10 includes a bio-sensor 12, a display screen 14, and a keypad 16. Bio-identification card 10 provides a secure means for providing user authentication for financial transactions and other account access conducted over the internet or other network communication system.

In one embodiment, bio-sensor 12 captures a sample biometric characteristic from a verified user, which preferably is generally unique to the user or an otherwise uncommon characteristic not shared by a large number of individuals. The sample biometric characteristic is compared to a signature biometric characteristic previously stored within bio-identification card 10. If it is determined that the sample biometric characteristic matches the signature biometric characteristic, a password or access code is provided to the user via display screen 14. In one embodiment, the password or access code is not provided to the user via display screen 14 until a user pin code is entered into bio-identification card 10 via keypad 16.

In any manner, the password provided via display screen 14 is typically a temporary password available and active for a limited time period, such as for 30 seconds. Accordingly, since the provided password is only active for a limited time period, an individual other than the user cannot steal or lift the password for use at a subsequent date and time. In addition, a non-authorized individual cannot utilize the bio-identification card 10 to access another temporary password, as the non-authorized user typically is unable to provide the sample biometric characteristic needed to match the signature biometric characteristic.

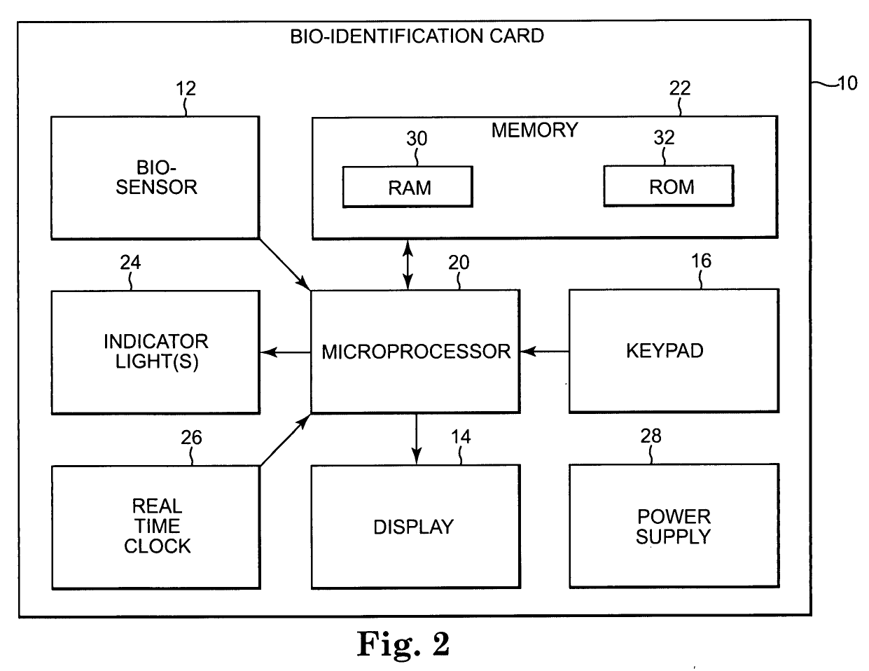

FIG. 2 illustrates a block diagram of one embodiment of bio-identification card 10. As illustrated, bio-identification card 10 includes bio-sensor 12, a microprocessor 20, a memory 22, an indicator light(s) 24, keypad 16, a real-time clock 26, display screen 14, and a power supply 28. As briefly described above, bio-sensor 12 is any sensor configured to capture a biometric characteristic from the user. For example, in one embodiment, bio-sensor 12 is configured to capture a biometric characteristic from the user such as an iris photograph, a retina photograph, a fingerprint, a voice track, facial photograph, DNA sample, etc. The biometric characteristic is a characteristic sufficiently unique to differentiate one individual from the next. With this in mind, embodiments of bio-sensor 12 include a retina scanner, a fingerprint scanner, an audio recorder, camera, or other suitable bio-sensor.

One example of a bio-identification sensor 12 is a camera 34 (illustrated in FIG. 1) that takes a picture of an eye of the user. In one embodiment, there is a reflective material 36 surrounding camera 34 to facilitate proper capture of the user eye being photographed. More particularly, bio-identification sensor 12 takes a picture of the iris and/or the retina of the eye. The picture is forwarded to microprocessor 20 for processing and future use as a signature biometric characteristic.

Another embodiment of bio-identification sensor 12 is an array of MEM switches to capture a fingerprint of the user, such as the fingerprint sensor currently available from Fidelica Microsystems of Milpitas, Calif. With this in mind, in one embodiment, the array of switches consists of 256 by 256 switches configured to capture the ridges of the user fingerprint. The fingerprint sensor outputs a binary signal for each of the switches indicating whether each switch was pressed by the user fingertip. The binary output is forwarded to microprocessor 20 for processing to determine the characteristics or signature of the fingerprint. Another example of a bio-identification sensor 12 is a face recognition camera.

Bio-sensor 12 is electrically connected to microprocessor 20. Microprocessor 20 is additionally coupled to each of the other components of bio-identification card 10 including memory 22, indicator light(s) 24, real-time clock 26, and power supply 28. Accordingly, microprocessor 20 facilitates interactions between these components and generally controls the actions of each of the components.

In one embodiment, microprocessor 20 is configured to further process or convert the collected biometric characteristic to facilitate future use of the biometric characteristic as a signature biometric characteristic. For example, microprocessor 20 applies one or more algorithms, such as Gabor wavelets, etc., to the retina or iris digital photograph to break down or convert the photograph into a byte signature to be stored as the signature biometric characteristic.

In one embodiment, microprocessor 20 is configured to note points of bifurcation and/or trifurcation in a user fingerprint captured by biosensor 12 and notes a “pattern” being formed between these noted points. The characteristics of the pattern are unique to each user. The identifying characteristics of the fingerprint are then stored as the signature biometric characteristic. The conversion of the biometric characteristic into the new format, such as the byte signature or the fingerprint pattern, provides the biometric characteristic in a readily comparable format.

Data used in a user enrollment or authentication process using bio-identification card 10 is stored within memory 22. In one embodiment, memory 22 includes a type of random access memory (RAM) 30 and a type of read-only memory (ROM) 32. RAM 30 provides general memory for use during the user authentication process. In one embodiment, ROM 32 or other non-volatile memory stores the signature biometric characteristic and the firmware used by microprocessor 20 to operate and perform the user enrollment and authentication processes. In addition, an encryption key is stored in ROM 32.

Indicator light or lights 24 include a single light or a plurality of lights for indicating the progress of the user authentication process. In one embodiment, indicator 24 includes a first light 40, a second light 42, and a third light 44 as illustrated with additional reference to FIG. 1. In one embodiment, the first and second lights 40 and 42 are each a red light, however, in one form of this embodiment, each red light 40 and 42 has a slightly different wavelength. In one embodiment, red light 40 or 42 is illuminated to indicate that a problem has occurred in the user enrollment or authentication process. In other embodiments, red lights 40 and 42 are used to signify progress along the enrollment or authentication process. In one embodiment, third light 44 is a green light generally illuminated to indicate a “go-ahead” to continue the user enrollment or authentication process. For example, upon matching a sample biometric characteristic to the signature biometric characteristic, green light 44 is illuminated.

Keypad 16 is any keypad commercially available in the art and providing a user interface to communicate with microprocessor 20 of bio-identification card 10. In one embodiment, keypad 16 provides for numerical and/or alphabetical input. In other embodiments, keypad 16 provides for alphabetical input in various languages such as Japanese, Chinese, etc., for personalized football symbols, flags, etc., and any other keypad themes or uses. In one embodiment, keypad 16 includes a key 46 to be depressed to activate bio-sensor 12. For example, in one embodiment, depression of key 46 of keypad 16 causes camera 34 to capture a subject, such as an iris, retina, or face. Although illustrated in FIG. 1 as being provided separate from display screen 14, in one embodiment, keypad 16 is provided via display screen 14 as a touch screen display.

Real-time clock 26 is any clock that accurately keeps track of the time for at least the useful life of bio-identification card 10. In one embodiment, real-time clock 26 includes and runs on a special dedicated battery that is not connected to the overall power supply 28. Accordingly, the functioning and time tracking mechanism of real-time clock 26 is not dependent upon an external power source and, therefore, is not reliant upon the continuity and consistency of external power source 28. In one embodiment, real-time clock 26 is synchronized to a real-time clock at a remote secure server for use in the user authentication process.

Display screen 14 is any display screen, such as a liquid crystal display (LCD) for communicating password and other information to the user form microprocessor 20. In one embodiment, display screen 14 is configured to provide a temporary password to the user upon completion of the user authentication process. In another embodiment, as illustrated in FIG. 1, display screen 14 includes visual manifestation of a countdown 52 indicating the remaining length of time for which the displayed password 50 will be valid. In one embodiment, countdown 52 is a plurality of increasingly small bars, a timer, time bar, etc. As briefly described above, in one embodiment, display screen 14 additionally includes touch screen buttons in place of or in addition to keypad 16 for providing an interface for user to communicate with microprocessor 20 of bio-identification card 10.

Power supply 28 is maintained within bio-identification card 10 and provides power to one or more of the bio-identification card components 12, 22, 24, 20, 16, 26, and/or 14. In order for bio-identification card 10 to last for a relatively long length of time, power supply 28 has a relatively long lifespan. Embodiments of power supply 28 include an energy coil able to be recharged when placed within proximity to a radio frequency (RF) source, an internal battery, an internal rechargeable battery, a super capacitor, or other suitable internal power source. More specifically, in one embodiment, power supply 28 includes an internal rechargeable battery rechargeable via RF source, such as a NICD cell or a super capacitor. In one embodiment, lower power design techniques are employed in the design of the remainder of bio-identification card 10 to reduce the necessary power that needs to be supplied by power supply 28. For example, power supply 28 may only supply power to bio-identification card 10 at times when bio-identification card is being used. If power supply 28 becomes completely depleted, power supply 28 can be replaced with an additional power supply similar to the power supply 28 defined herein. In other embodiments, upon depletion of power supply 28, bio-identification card 10 is disposed and a replacement bio-identification card is obtained by the user.

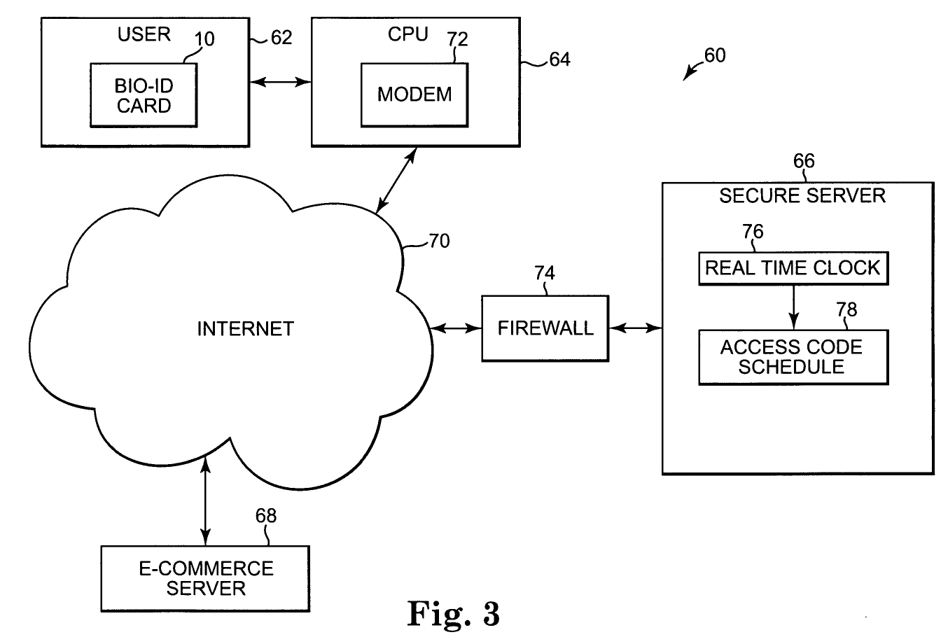

One embodiment of a bio-identification system or user authentication system is illustrated generally at 60 in FIG. 3. User authentication system 60 employs a bio-identification card, such as bio-identification card 10. In one embodiment, user authentication system 60 includes a user 62, a control processing unit (CPU) 64, a secure server 66, and an e-commerce server 68. User 62 is any user wishing to complete a financial transaction or otherwise access a financial account via a network system, such as the internet 70. Computer processing unit 64 is any computer processing unit capable of accessing internet 70 and providing a user interface to internet 70 to complete a financial transaction or other account access. Accordingly, CPU 64 includes a modem 72 configured to link CPU 64 to internet 70. Modem 72 is any device or program that enables CPU 64 to transmit data via internet 70. In one embodiment, modem 72 converts digital information for transmission in analog wave format.

E-commerce server 68 is any suitable server of a business conducting commerce over the internet using any of the applications that rely on the internet, such as e-mail, instant messaging, shopping carts, web services, FTP, EDI, and the like. Electronic commerce can be between two businesses or a person and business transmitting funds, goods, services and/or data between them. In other embodiments, e-commerce server 68 is an operating server for a bank, financial institution, or other business.

Secure server 66 is a financial institution or other business server protected from unauthorized penetration through internet 70 via security devices, such as a firewall 74. In particular, in one embodiment, a stop firewall 74 is provided between internet 70 and secure server 66 to prevent or generally decrease the amount of unauthorized access to secure server 66.

In one embodiment, secure server 66 includes a real-time clock 76 and an access code schedule 78. Real-time clock 76 is similar to real-time clock 26 described above. In particular, real-time clock 76 is synchronized with real-time clock 26 of bio-identification card 10. Access code schedule 78 is either a predetermined schedule or dynamic algorithm for determining a temporary access code for each given time period in a day, week, month, etc.

For example, in one embodiment, a different access code is provided for each 30 second increment of time. Accordingly, any password provided by user as determined from bio-identification card 10 is checked against access code schedule 78 to determine if that particular access code is valid and active at the time period in which the access code 15 entered into CPU 64. Accordingly, access code schedule 78 matches a particular method for determining an access code to be provided to user 62 via display screen 14 as stored in bio-identification card 10. In this manner, by using access code schedule 78 and synchronized real-time clock 76, secure server 66 is capable of verifying, authenticating, and/or validating a user 62 to access a particular financial account or other account. In one embodiment, internet 70, secure server 66, and e-commerce server are each part of an access guard system.

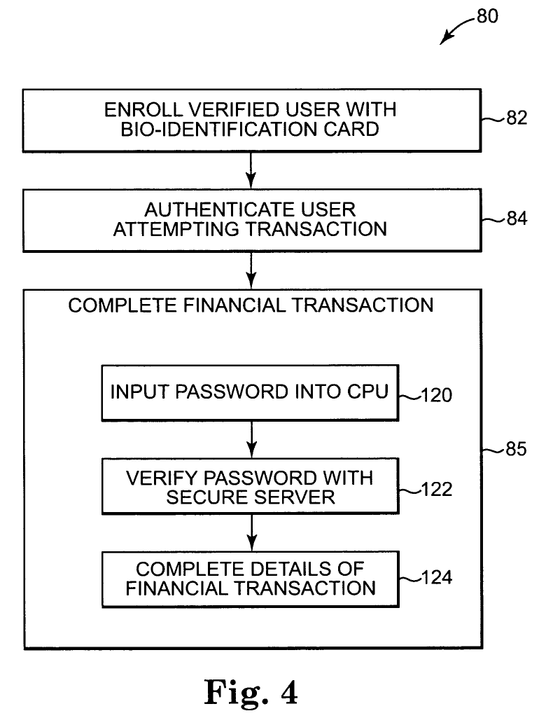

One embodiment of a bio-identification method is generally illustrated at 80 in FIG. 4. Bio-identification method 80 employs a bio-identification card, such as bio-identification card 10. At 82, a verified user 62 is enrolled with bio-identification card 10 to securely link bio-identification card 10 with the particular user 62. In one embodiment, user 62 is enrolled with bio-identification card 10 at a secure setting, such as a bank or other secure location, under the supervision of bank or other security personnel able to otherwise verify the identity of user 62, thereby, promoting the integrity of the enrollment process.

After enrollment at 82, bio-identification card 10 is employed to authorize or de-authorize an unknown user to complete a financial transaction to gain account access at 84. User authentication process 84 does not need to be completed at a secure institution. Upon completion of user enrollment process 82 and user authentication process 84, the financial transaction is completed by the user at 85.

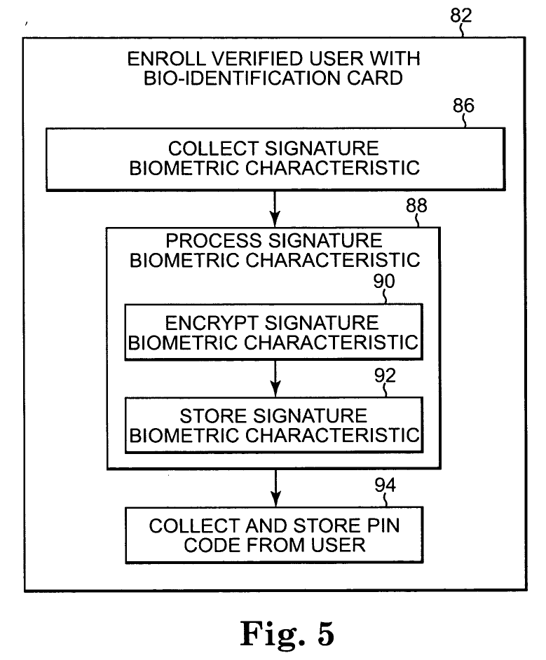

FIG. 5 more particularly illustrates the method of enrolling a verified user with bio-identification card 10 at 82. At 86, a signature biometric characteristic is collected from verified user 62. For example, where the biometric characteristic is iris or retina properties, a picture of the eye of the user is taken with camera 34. More specifically, verified user 62 aligns his or her eye with camera 34 and depresses key 46 to collect the photograph of the user eye. In one example, to capture a signature biometric characteristic of the eye, two pictures are sequentially taken of the eye to evaluate depth of the eye and to generally prevent user 62 from photographing an existing picture of an eye rather than photograph the eye of the user 62, itself. In other instances, other biometric characteristics, such as a user fingerprint, are taken by bio-sensor 12. In still other instances, multiple biometric characteristics, such as vocal characteristics and fingerprint characteristics, are gathered and collectively used to establish identity.

At 88, the biometric characteristic is processed or converted into a readily comparable format. Once again, following the example of the iris or retina biometric characteristic, processing of the biometric characteristic includes applying various algorithms, such as Gabor wavelets and other various algorithms to provide a byte signature, for example, as in the method provided by Iridian Technology, Inc. of Moorestown, N.J., to produce a signature biometric characteristic. The byte signature is able to be compared to other signatures to determine the individual to whom the particular picture of the iris or retina belongs.

In one embodiment, the signature biometric characteristic is encrypted at 90. More specifically, in one embodiment, microprocessor 20 access an encryption code or key from RAM 30 and applies it to the signature biometric characteristic. Encryption of the signature biometric characteristic provides further protection against pirating or identification theft of bio-identification card 10. In other embodiments, the signature biometric characteristic is not encrypted.

At 92, the encrypted signature biometric characteristic is stored within RAM 30 of memory 22 for future reference. In one embodiment, in which a keypad 16 is provided on bio-identification card 10, at 94, a pin code is collected from user 62 and stored to memory 22. In particular, in one embodiment, user 62 enters a four to eight digit pin code to bio-identification card 10 via keypad 16. Microprocessor 20 receives the pin code and stores the pin code to RAM 30 for future reference. In one embodiment, the pin code is encrypted prior to storage within RAM 30. In other embodiments, no pin code is stored for verified user 62 at 94. In one embodiment, another secure code or serial number individual to bio-identification card 10 is stored in memory 22 for future reference as will be described below.

Moreover, in one embodiment, indicator light(s) 24, such as light 40, 42, and 44 are periodically illuminated individually or in a particular pattern or combination to indicate the completion of at least one of the steps 86, 88, 90, 92, or 94 to prompt a user to continue through the enrollment process 82. For example, while photographing an eye of user 62, red light 40 and/or 42 are illuminated and once the photographing is complete, green light 44 is illuminated indicating that user 62 is free to move his/her eye away from camera 34.

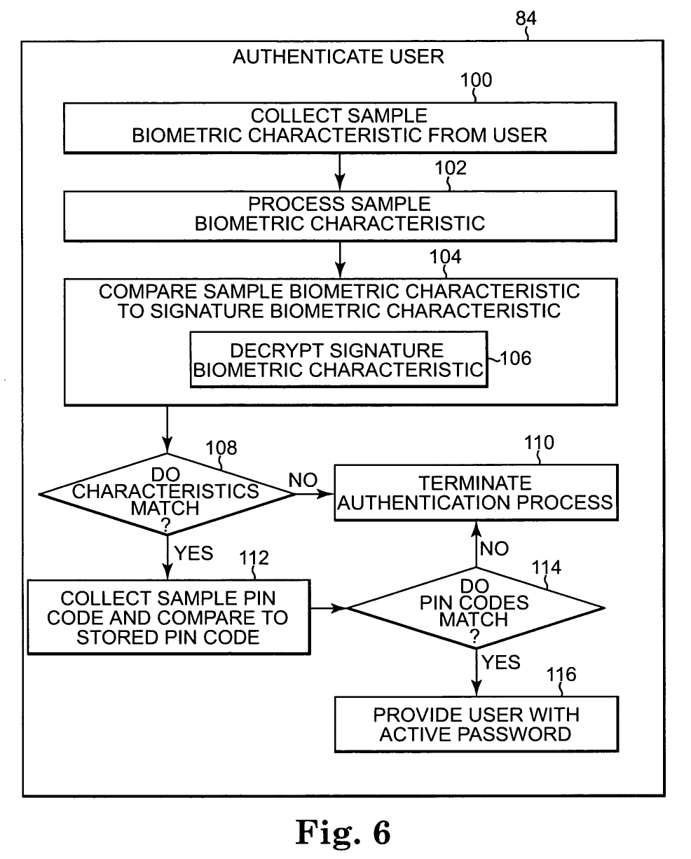

FIG. 6 more particularly illustrates a user authentication process 84. User authentication process 84 is able to be completed periodically at any time following completion of user enrollment process 82. User authentication process 84 is more particularly completed when an unknown user wishes to complete a financial transaction or to otherwise access a financial or consumer account.

At 100, a sample biometric characteristic is collected from the unknown user who may be verified user 62 or any other individual attempting authorization with bio-identification card 10. The sample biometric characteristic is collected from the unknown user in a similar manner as described with respect to collection of a signature biometric characteristic at 86, in other words, by capturing an eye photograph, fingerprint scan, etc. Moreover, at 102, the biometric characteristic collected at 100 is processed in a similar manner as described above with respect to processing signature biometric characteristic 88. For example, a sample biometric characteristic of a retina or iris is processed or converted into a byte sample or a sample fingerprint is processed or converted to derive a pattern for comparison. In one embodiment, the newly processed biometric characteristic is not encrypted or stored within RAM 32.

After processing, at 104 the sample biometric characteristic is compared to signature biometric characteristic. In particular, at 106, the previously processed signature biometric characteristic is decrypted and compared to the processed sample biometric characteristic. In one embodiment, the sample biometric characteristic and the signature biometric characteristic are each in a processed formed during comparison. At 108, the results of the comparison at 104 are analyzed to determine whether the sample biometric characteristic matches the signature biometric characteristic. If the characteristics are not found to match, then at 110, the user authentication process 84 is terminated as the unknown user is not verified user 62. In this case, the unknown user is prevented from completing the financial transaction or accessing the commercial account. If, however, the sample biometric characteristic matches the signature biometric characteristics, the unknown user is likely verified user 62 and authentication process 84 continues.

In embodiments in which a pin code was collected during user enrollment process 82, at 112, a pin code is collected from the unknown user via keypad 16. The newly collected pin code is compared to the pin code stored within memory 22. At 114, it is determined whether the pin code matches the stored pin code. If the pin codes do not match, then at 110, the user authentication process 84 is terminated since the unknown user is not likely the verified user, and the unknown user is not permitted to complete the financial transaction or account access. If, however, at 114, it is determined that the pin code matches the stored pin code, then at 116, unknown user 62 is assumed to be verified user 62 and is provided with a password to authorize completion of a financial transaction. In other embodiments, another secure code or serial number individual to bio-identification card 10 is additionally or alternatively entered by user 62 and compared within bio-identification card 10 to further verify user 62. In one embodiment, the password is provided to verified user 62 via display screen 14, an RF transmission, an IrDA, or a pulsed modulation of indicator lights 24.

In one embodiment, the password provided to the user 62 at 116 is a temporary password, which is only valid and active for a limited time period, such as for 30 seconds. Accordingly, upon display of password to user via display screen 14 of bio-identification card 10, display screen 14 additionally illustrates an indication of the time period for which the provided password is valid and active. As the time in which the provided password is valid dwindles, the display screen 14 indicates the passage of time by movement of a clock arm, by deletion or shortening of time bars, countdown 52, etc. In one embodiment, each of the entire user enrollment process 82 and user authentication process 84 is completed within bio-identification card 10.

As indicated at 85 in FIG. 4, the user completes the financial transaction after the user enrollment process 82 and user authentication process 84. In the illustrated embodiment, at 120, the user enters the password provided at 116 into CPU 64. In particular, the provided password is transmitted from CPU 64 via internet 70 and e-commerce 68 to secure server 66. At 122, upon receipt of the password, secure server 66 compares the received password to the synchronized access code schedule 78 in view of real-time clock 76 to determine if the provided password matches the active and valid password expected by secure server 66.

In one embodiment, additional codes known to user 62 or individual to bio-identification card 10 are also communicated to secure server 66 to provide additional means of authorizing the account transaction or access. In one embodiment, secure server 66 additionally or alternatively provides a random challenge code to bio-identification card 10, which receives and processes the random challenge code through a predefined algorithm. As a result of the processing, bio-identification card 10 outputs a response code to secure server 66 that is unique to the specific transaction being authenticated. Secure server 66 compares the response code to an expected code prior to or in addition to providing a password to provide additional security to the authorization process.

If the provided password matches the password expected by secure server 66, secure server 66 notifies e-commerce server 68 that the financial transaction may take place and is duly authorized. As such, the password is verified as a secure password at step 122. Once the transaction is authorized by secure server 66, then at 124, the user completes financial transaction details with e-commerce server 68 per the normal protocol of e-commerce server 68. Following the process at step 124 and final verification of the financial transaction by the user, the financial transaction is completed via internet 70 with e-commerce server 68 and the participating financial institution or commercial entity. Alternatively, if the password received does not match the password expected by secure server 66, secure server 66 notifies e-commerce server 68 that the transaction or access is not authorized, thereby, preventing the user from completing the transaction and/or desired access.

Accordingly, by using bio-identification card 10, theft identity or pirating can be decreased due to the level of security provided by bio-identification card 10. In particular, bio-identification card 10 identifies a user by a biometric characteristic and/or a pin code. In particular, use of a biometric characteristic is particularly difficult to replicate by identity thieves. Since the biometric characteristic is difficult to replicate, it is difficult for identification thieves to utilize bio-identification card 10 to determine an active password at any particular time. In addition, since neither the sample or signature biometric characteristic is transmitted over internet 70, the biometric characteristic itself cannot easily be pirated and stolen for performing future un-authorized transactions or for gaining future unauthorized access. Even in the event that the one-time use password were discovered by an unauthorized individual, the password cannot be reversely analyzed to determine the signature biometric characteristic or associated pin code. In this respect, embodiments of bio-identification card 10 provide for extremely secure methods of authorizing financial transactions over a network or internet.

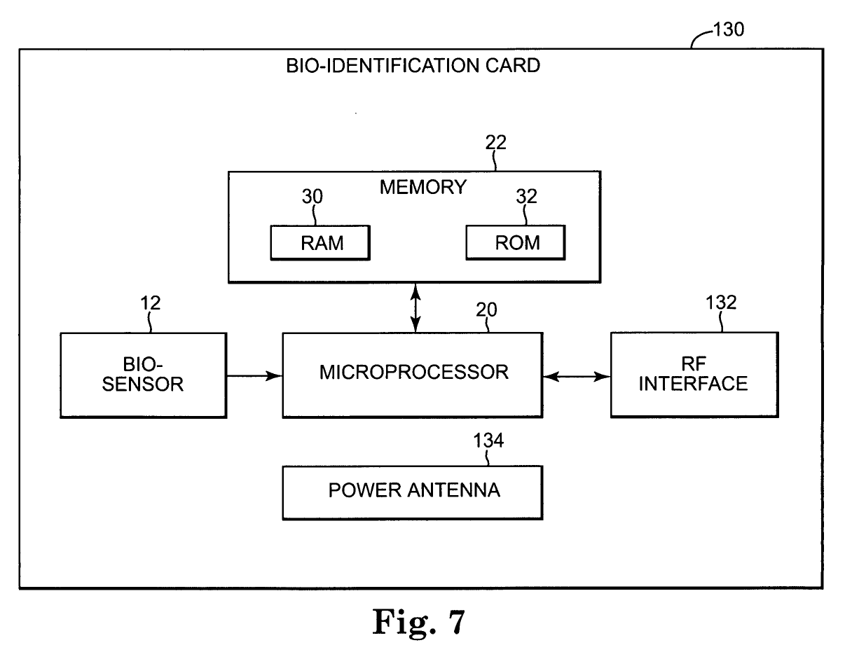

FIG. 7 illustrates another embodiment of a bio-identification card generally at 130. Bio-identification card 130 is sized and shaped similar to bio-identification card 10 (illustrated in FIGS. 1 and 2). Moreover, bio-identification card 130 includes bio-sensor 12, microprocessor 20, and memory 22 similar to bio-identification card 10. Bio-identification card 130 additionally includes an optical communication interface, such as a radio frequency (RF) interface 132, an infrared data association (IrDA) interface, etc., and a power antenna 134. RF interface 132 is configured to send and receive RF communication waves to and from a card reader or similar device. Similarly, an IrDA interface is configured to send and receive Infrared communication waves to and from a card reader or similar device.

In one embodiment, power antenna 134 includes energy coils configured to power up or energize when placed in proximity to a RF energy source. Accordingly, upon powering up, power antenna 134 provides power to the entire bio-identification card 130 as necessary to complete the enrollment and/or authorization process. In one embodiment, power antenna 134 is placed in proximity to an RF energy source each time bio-identification card 130 is used. With this in mind, bio-identification card 130 generally has available power during all times of use. In other embodiments, a battery or other power source is included in bio-identification card 130 in addition to or as an alternative to power antenna 134.

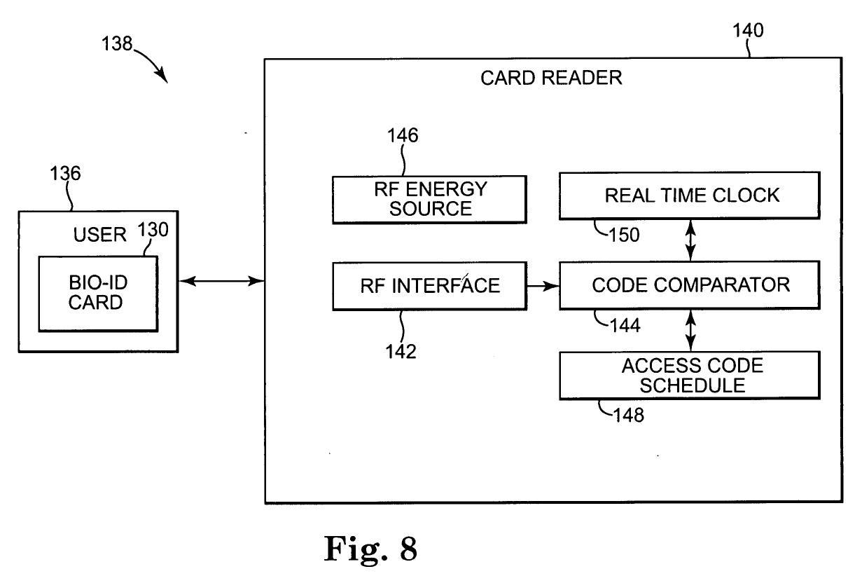

One embodiment of a bio-identification system or user authentication system, which employs a bio-identification card, such bio-identification card 130, is generally illustrated at 138 in FIG. 8. In addition to bio-identification card 130, user authentication system 138 includes a user 136, similar to user 62 (illustrated in FIG. 2), and a card reader 140, which is an access guard system. In one embodiment, card reader 140 is positioned near or outside a restricted access area or object. Card reader 140 includes an optical communication interface, such as an RF interface 142, an IrDA interface, etc., a code comparator 144, and an RF energy source 146. RF interface 142 is configured to communicate with RF interface 132 of bio-identification card 130. In particular, RF interface 142 is configured to receive an RF access code from bio-identification card 130. Similarly, in one embodiment, an IrDA interface of card reader 140 is configured to communication with an IrDA interface of bio-identification card 130 to receive an IrDA access code.

Code comparator 144 is configured to compare the RF, IrDA, or other optically communicated access code from bio-identification card 130 to the active and valid access code that will provide admittance to the restricted area or object the user is attempting to access. In one embodiment, code comparator 144 includes a real-time clock 150 and an access code schedule 148 for use with a temporary access codes provided by bio-identification card 130 based upon a real-time clock (not shown) and similar schedule (not shown) of bio-identification card 130.

RF energy source 146 provides RF energy to bio-identification card 130 when bio-identification card 130 is placed within a general proximity to card reader 140. In one embodiment, RF energy source 146 provides RF energy waves to bio-identification card 130, which “power up” or energize power antenna 134, so that power antenna 134 can provide power to bio-identification card 130.

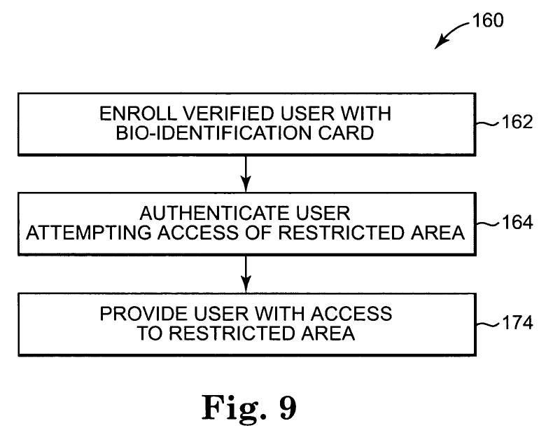

FIG. 9 illustrates one embodiment of a bio-identification method which employs a bio-identification card, such as bio-identification card 130, generally at 160. At 162, verified user 136 is enrolled with bio-identification card 130 in a similar manner as verified user 62 is enrolled with bio-identification card 10 at 82 described above. In one embodiment, no pin code is utilized in enrollment process 162.

At 164, an unknown user, which may be verified user 136 or any other individual, attempting to access a restricted area, such as building, a room, a building area, a computer, an online account, an airplane, a country, etc., is authenticated. Similar to the authentication process described above at 84, authentication at 164 includes steps 100, 102, 104, 108, and 110 completed by bio-identification card 130. However, if at 108, the sample biometric characteristic matches the signature biometric characteristic, then at 172, bio-identification card 130 transmits a RF access code as dictated by memory 22 via RF interface 132 to card reader 140.

In one embodiment, RF access code is a temporary code or password valid and active for a limited time. Although described herein as being communicated via RF energy, the access code alternatively is communicated between bio-identification card 130 and card reader 140 via a magnetic strip, wire, etc. If at 108, the sample biometric characteristic does not match the signature biometric characteristic, authentication process 164 is terminated at 110 and the unknown user is prevented from accessing the restricted area or object.

Returning to FIG. 9, at 174, the RF access code transmitted by bio-identification card 130 to card reader 140 is analyzed to determine the active access code to the restricted area. If the access code transmitted is the same as the access code expected by card reader 140 at the given time, then the user is provided with access to the restricted area, such as a computer, building, room, account, etc. More specifically, upon receiving a valid and active access code, card reader 140 effectuates the unlocking of a door, inactivation of an alarm, etc. to provide user 136 access to the restricted area.

In one embodiment, components of bio-identification cards 10 and 130 are interchangeable. For example, bio-identification card 10 may include an RF interface 132 and/or bio-identification card 130 may include a real-time clock 26 and code schedule to output a one-time only code to card reader 140 via RF interface 132. In one embodiment, similar technology utilized in bio-identification card 10 and 130 are integrated in driver's licenses, passports, credit cards, etc. For example, a passport contains an encrypted signature biometric characteristic. When a user passes through a passport control station, a sample biometric characteristic is collected by the station, processed, and compared to the signature biometric characteristic stored in the passport. A match of the sample biometric characteristic to the signature biometric characteristic verifies the user is the true owner of the passport.

An authorization system and bio-identification card as described above provides desirable safeguards against identity theft and allows users to make online financial transactions with a higher degree of security. For example, most biometric characteristics are difficult if not impossible to replicate making it difficult for a thief to obtain a password or access code from the bio-identification card. In addition, since the biometric characteristic is compared to the previously stored signature biometric characteristic within the bio-identification card itself, the biometric characteristic is not transmitted over a network or with RF energy. Since the biometric characteristic is not exposed over the internet or with RF energy, the danger of having the actual biometric characteristic stolen or pirated is generally minimized or decreased. With the above in mind, consumer users are able to complete network financial transactions with additional piece of mind.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An identification card comprising:
a bio-sensor configured to collect a signature biometric characteristic from a verified user;
a memory configured to store the signature biometric characteristic; and
a microprocessor coupled to the bio-sensor and the memory, wherein the microprocessor is configured to retrieve the signature biometric characteristic from the memory and to perform a comparison between the signature biometric characteristic and a sample biometric characteristic.

2. The identification card of claim 1, wherein the bio-sensor is configured to collect the sample biometric characteristic from an unknown user, and the microprocessor is configured to compare the sample biometric characteristic to the signature biometric characteristic.

3. The identification card of claim 1, wherein the memory stores an encryption key, the microprocessor is configured to encrypt the signature biometric characteristic based on the encryption key, and the encrypted signature biometric characteristic is stored in memory.

4. The identification card of claim 1, wherein the biometric characteristic includes at least one of a fingerprint, a retina scan, an iris photograph, a facial photograph, a voice-print, and a DNA sample.

5. The identification card of claim 1, further comprising at least one indicator light for indicating the progress of at least one of an enrollment process employing the identification card and an authorization process employing the identification card.

6. The identification card of claim 1, further comprising:
an output mechanism configured to externally provide an access code or password from the microprocessor.

7. The identification card of claim 6, wherein the output mechanism is a display screen.

8. The identification card of claim 6, wherein the output mechanism is an optical communication interface.

9. The identification card of claim 1, further comprising
a power supply configured to provide power to the identification card.

10. The identification card of claim 9, wherein the power supply comprises a rechargeable battery which is rechargeable via a radio frequency source.

11. The identification card of claim 1, wherein the identification card is sized to fit within a wallet.

12. An authentication system comprising:
an identification card comprising:
a bio-sensor configured to collect a signature biometric characteristic from a verified user and configured to collect a sample biometric characteristic from an unknown user,
a memory configured to store the signature biometric characteristic, and
a microprocessor coupled to the bio-sensor and the memory and configured to compare the sample biometric characteristic to the signature biometric characteristic, wherein the microprocessor is configured to provide access data based on the comparison; and
an access guard system configured to receive the access data and configured to determine whether the unknown user is authorized to access a restricted area.

13. The authentication system of claim 12, wherein the restricted area is one of a building, a room, a building area, a computer, an online account, a financial account, an airplane, and a country.

14. The authentication system of claim 12, wherein the access guard system comprises a card reader including an optical communication interface for receiving the access data from the identification card.

15. The authentication system of claim 12, wherein the access guard system includes a secure server and a network.

16. The authentication system of claim 12, wherein the access guard system is configured to permit the user to access the restricted area if the access data matches an expected access data of the access guard system.

17. The authentication system of claim 12, wherein access guard system is configured to permit the user to gain access to the restricted area based on access data corresponding to a temporary period of time.

18. The authentication system of claim 12, wherein the identification card includes a first clock and the access guard system includes a second clock synchronized with the first clock.

19. A bio-identification method comprising:
enrolling a verified user with an identification card including:
collecting a signature biometric characteristic from the verified user via a bio-sensor of the identification card,
converting the signature biometric characteristic with a microprocessor of the identification card into a readily comparable format, and
storing the signature biometric characteristic to a memory of the identification card.

20. The method of claim 19, further comprising:
encrypting the signature biometric characteristic with an encryption key stored in the memory of the identification card.

21. The method of claim 19, further comprising:
authenticating an unknown user and determining whether to provide the unknown user including:
collecting a sample biometric characteristic from the unknown user via the bio-sensor,
converting the sample biometric characteristic with the microprocessor into a readily comparable format, and
comparing the converted sample biometric characteristic to the converted signature biometric characteristic.

22. The method of claim 19, further comprising permitting the unknown user to access a restricted area if the sample biometric characteristic matches the signature biometric characteristic.
